(19) United States
(12) Patent Application Publication
(10) Pub. No.: US 2013/0316311 A1
(43) Pub. Date: Nov. 28, 2013

(54) DRIVING MONITORING SYSTEM

(71) Applicant: Drive Power, LLC, St. Paul, MN (US)

(72) Inventor: William D. England, Minneapolis, MN (US)

(73) Assignee: Drive Power, LLC, St. Paul, MN (US)

(21) Appl. No.: 13/901,032

(22) Filed: May 23, 2013

Related U.S. Application Data
(60) Provisional application No. 61/651,172, filed on May 24, 2012.
(60) Provisional application No. 61/667,523, filed on Jul. 3, 2012.

(51) Int. Cl. G09B 19/16

(52) U.S. Cl. CPC G09B 19/167
USPC 434/65

(57) ABSTRACT

A system and method are provided for monitoring driving behavior in real time, which is then used to assign points to a user, such as the driver, a passenger, friends of the driver or passenger, and the like. The assignment of points can be effective at influencing current and future driving behavior of users via gamification and social networking. Users of the described system and method can engage with each other in a fun, competitive, and social way, using leaderboards, contests, points and rewards, and other gamification concepts. The system and method may be loaded onto a smartphone and may be auto-controlled based on one or more predetermined trigger events, which may be internally or externally controlled. An occurrence of the trigger event may cause the system to auto-start or to auto-end without the user interacting with the smartphone.

### CROSS-REFERENCE TO RELATED APPLICATIONS

The present application claims priority to U.S. Provisional Application 61/651,172 filed on May 24, 2012 and entitled Safe Driving Coaching System and Method and also claims priority to U.S. Provisional Application 61/667,523 filed on Jul. 3, 2012 and entitled Auto Control of Safe Driving Coaching Smartphone Application, the contents of each of which are hereby incorporated by reference herein in their entireties.

### FIELD

This disclosure relates to a system and method for monitoring driving behavior and promoting safe driving using an application loaded onto a smartphone, and automatically turning the application on and/or off.

### BACKGROUND

Distracted driving has become a major contributing factor to auto accidents, injuries and unnecessary loss of life. This is particularly acute among those who feel compelled to stay connected via their mobile phones. Techniques that teach and promote safe driving habits are therefore desirable.

### SUMMARY

A system and method are described that teach and promote safe driving. The driving behaviors of a driver of a motor vehicle is monitored in real time, which is then used to assign points to a user, such as the driver, a passenger, friends of the driver or passenger, and the like. The assignment of points can be effective at influencing current and future driving behaviors of users.

The system and method can be employed with any type of vehicle including, but not limited to, automobiles, trucks, motorcycles and the like. A vehicle as used herein is also intended to encompass motorboats, sail boats, and other maritime vessels.

Assigned points as used herein is intended to encompass the assignment of any units of measure based on driving behavior. Points can be simple numbers, for example 100, or represented by a currency amount, for example $100, or any other units of measure.

The assignment of points based on driving behavior can facilitate gamification to make the system and method more enjoyable and thereby encourage safe driving habits. Gamification includes not only the awarding of points, but also the implementation of games, challenges, and competitions against others, redemption of points for prizes or services, social networking opportunities, and many other possible gamification concepts. Users of the described system and method can engage with each other in a fun, competitive, and social way, using leaderboards, contests, points and rewards, and other gamification concepts. This forms what can be loosely referred to as a safe driving community of users.

The driving behavior of the driver of the motor vehicle can be monitored in many different ways. For example, one way to monitor driving behavior is by an application that is loaded onto a smartphone of an occupant of the vehicle as will be discussed further below. The smartphone could belong to the driver, or to a passenger of the vehicle. Other ways to monitor driving behavior include, but are not limited to, an aftermarket device specifically designed for use in a vehicle, or a device integrally built into the vehicle. Any means that are capable of monitoring driving behavior in real time can be used.

In one embodiment, the system includes a server that receives data relating to the driving behavior of the driver of the motor vehicle. Based on the received data, the server can award points. The points can be awarded to the driver of the vehicle and/or one or more passengers in the vehicle, as well as to others not in the vehicle such as friends or family of the driver and/or passengers.

In another embodiment, a web portal is provided. The web portal allows a user to access their account to view points information and other data. The web portal can be hosted by the same server that receives the driving behavior data or by a separate server. Either or both of the servers could be local or cloud based.

Techniques of automatically controlling an application that is loaded onto a smartphone are also described, where the application can be automatically turned on to run the application and/or automatically turned off to end the application. The auto-control described herein is most useful in auto-starting the application. However, the auto-control can also be used to auto-end the application either in addition to, or separately from, the auto-start.

In some embodiments, the application is directed to a safe driving coaching system that is configured to monitor driving behavior, with the application loaded onto a smartphone of an occupant of the vehicle as will be discussed further below. The smartphone could belong to the driver, or to a passenger of the vehicle.

The safe driving coaching system application loaded onto the smartphone can be auto-controlled (i.e. started or stopped) based on one or more predetermined trigger events. The trigger events can be internally configured into the application, and presented to the user via the user interface of the smartphone to allow the user to select a particular trigger event. The trigger events can also be non-user selectable, resulting from one or more external signals being received by the smartphone having the safe driving coaching system application loaded thereon. Regardless of whether the trigger event(s) is user selectable or not user selectable, occurrence of the trigger event causes the safe driving coaching system application to auto-start or to auto-end without the user interacting with the smartphone.

As used herein, the terms “auto-control”, “automatically control”, “auto-start”, “auto-end” and the like, mean that the safe driving coaching system application (or other application loaded onto a smartphone) automatically starts/ends without requiring user interaction with smartphone. In other words, the user of the smartphone is not required to participate in starting the application or ending the application through interaction with the smartphone.

### DRAWINGS

FIG. 1 is a schematic diagram of one embodiment of a safe driving coaching system.

FIG. 2A is a flow diagram illustrating one exemplary embodiment of monitoring driving behavior and awarding points using the safe driving coaching method.

FIG. 2B is a flow diagram illustrating one exemplary embodiment of the functionality of the web portal of the safe driving coaching method.

FIG. 3 illustrates an exemplary screenshot of a smartphone display screen showing the preferences screen allowing a user to select settings for auto-start of the safe driving coaching system application.

FIG. 4 illustrates an exemplary screenshot of a smartphone display screen showing exemplary user selectable trigger events.

### DETAILED DESCRIPTION

Before describing the auto-control features of the safe driving coaching system application, an example of the safe driving coaching system and application will first be described.

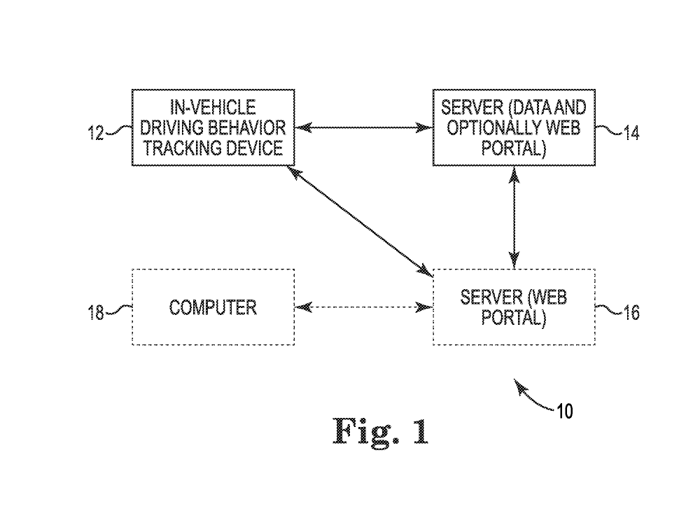

With reference to FIG. 1, one exemplary embodiment of a safe driving coaching system 10 is illustrated. In this example, the system 10 includes an in-vehicle tracking device 12, a first server 14, an optional second server 16 and optionally a computer 18.

The in-vehicle tracking device 12 is preferably a smartphone that can belong to a driver of a vehicle or to a passenger of the vehicle, and the smartphone is in the vehicle to provide real time tracking of driving behavior. As discussed further below, the smartphone includes an application installed thereon that permits tracking of certain driving behaviors of the driver during a driving session and transmission of data regarding the driving behaviors during the driving session to a remote location. The smartphone can be any type of device that enables one or more of the driver behavior tracking functions discussed below. Examples of suitable smartphone devices include, but are not limited to, smartphone devices using the Android® operating system, or the iPhone® line of smartphones.

The in-vehicle tracking device 12 will hereinafter be described as being a smartphone. However, the in-vehicle tracking device 12 can be any device capable of monitoring driving behavior in real time. Other in-vehicle tracking devices can include, but are not limited to, an aftermarket device specifically designed for use in a vehicle similar to the Progressive Snapshot device, or a device integrally built into the vehicle.

In use, the smartphone 12 collects data regarding the driving behavior of the driver during the driving session and automatically sends that data to the server 14. The data can be transmitted real time, in near real time, or at specified transmission times, using the standard data transmitting capabilities of the smartphone which are well known.

The server 14 receives the data, and based on the data, calculates and awards points for that driving session. The points can be awarded to the driver of the vehicle and/or one or more passengers in the vehicle, as well as to others not in the vehicle such as friends or family of the driver and/or passengers. The awarded points are stored in a user account that the user can access via a web portal discussed further below. The server 14 can also send certain data back to the smartphone 12 before, during and after the driving session, such as real time warnings and explanations during the driving session based on the monitored driving behavior to help educate the driver/passenger and influence driver behavior, information on the points earned during the driving session and total earned points in the user's account, leaderboards (discussed further below), and other data.

In some embodiments, the server 14 may also send information regarding the driver's driving behavior to a third party, such as the parents of the driver or an employer, alerting the third party of good or bad driving behavior by the driver.

A web portal can also be provided to allow a user to go on-line and access their user account. The web portal can be hosted on the server 14. More preferably, the web portal is hosted on the server 16 in order to separate the data processing functions of the server 14 from the web hosting duties of the server 16. Either or both of the servers could be local or cloud based.

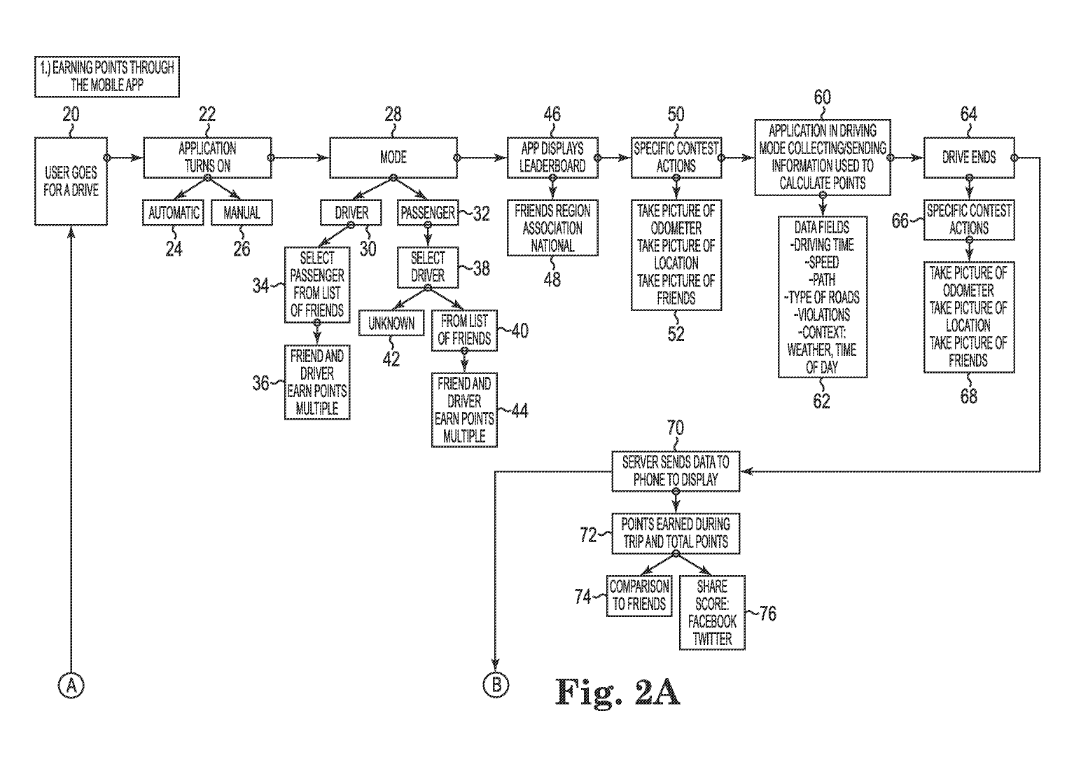

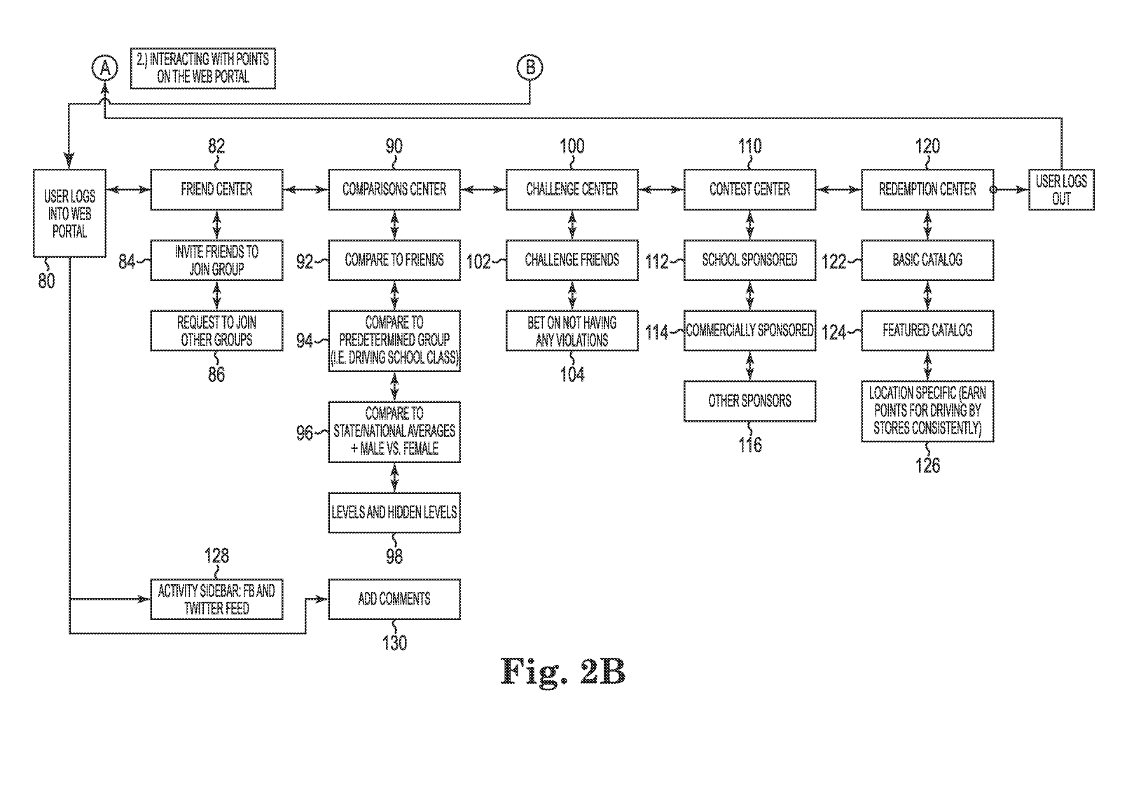

The web portal, an example of which will be further described below with reference to FIG. 2B, permits a user to access and view their user account using the web browsing functionality of the smartphone 12 or via the computer 18, such as a home or work computer, or a tablet computer. The web portal can accessed via the web through any device including, but not limited to, desktop computers, tablet computers and mobile devices.

Turning now to FIG. 2A, one exemplary embodiment of a safe driving coaching method that monitors driving behavior and awards points based thereon is illustrated. In describing FIG. 2A, it is assumed that the user has downloaded the application onto their smartphone and has registered to use the system. The user can obtain the application for their smartphone in any suitable manner, such as by obtaining and downloading the application from a website. The user will also need to register to use the system so that a user account can be set-up for the user. In cases where the user is a minor (i.e. under the age of 18), a parent or guardian may need to register the user and/or sign a parental consent form since the system involves tracking the location of the user using the user's smartphone. The smartphone application and registering to use the system may be free or it may be fee-based.

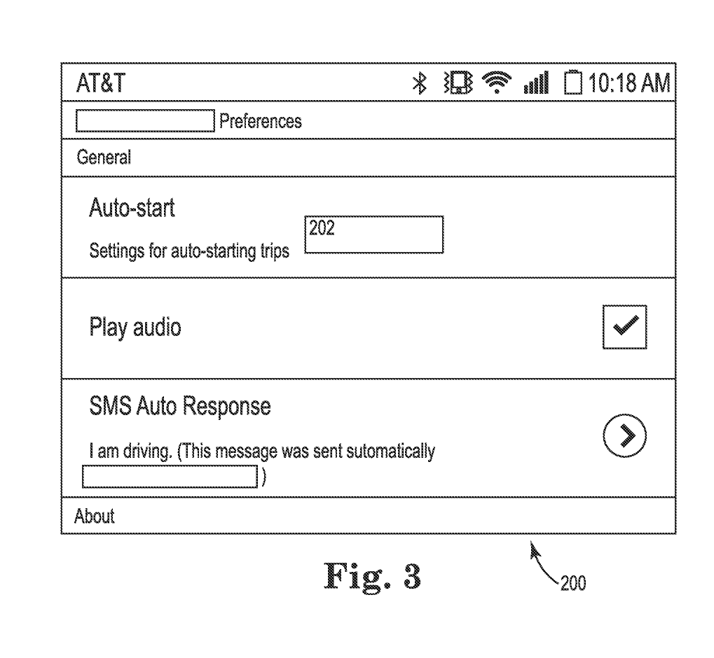

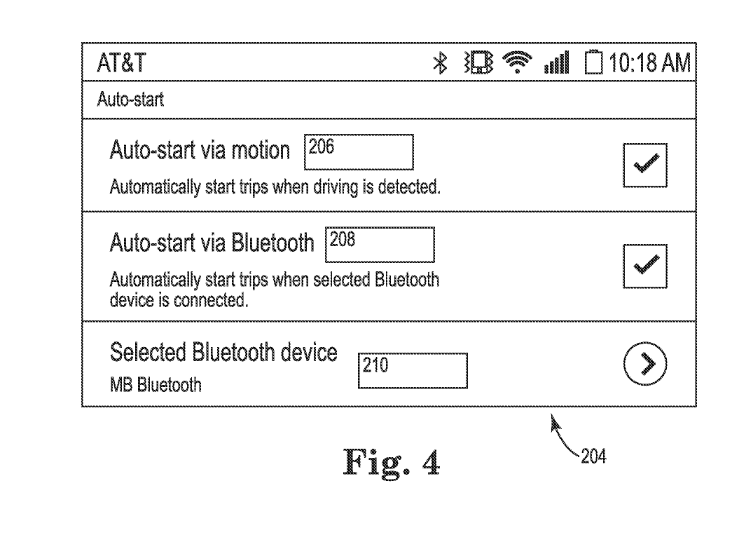

Once the application has been downloaded onto the user's smartphone and registration completed, the system is ready to be used. As indicated in FIG. 2A, the method starts by the user going for a drive 20. The smartphone application is then turned on 22. The application can be turned on automatically 24, for example by using a GPS device on the smartphone to detect movement of the user or by the vehicle's Bluetooth technology as discussed further below with respect to FIGS. 3 and 4. Alternatively, the application can be turned on manually 26 by the user by pressing a start “button” on the application user interface on the smartphone.

The method can also allow the user to select the mode 28 of operation. For example, the user can select Driver 30 if they are the driver of the vehicle, or Passenger 32 if the user is a passenger of the vehicle. If the user selects Driver 30, the user may then be presented with the option of selecting one or more passengers of the vehicle from a list of friends 34. This helps to encourage use of, and enhance the social experience of, the system and method for certain segments of users, such as teenagers. If a passenger is selected, the driver and selected passengers/friends may be eligible to earn point multiples 36 above and beyond what they would normally have earned without selecting a passenger/friend.

Similarly, if the user selects Passenger 32 indicating that they are a passenger in the vehicle. In this case, the user can be asked to select the driver 38 from a drop down list 40 of friends and family. If the user does not know the driver or the driver is not on the drop down list 40, the user can proceed on the basis of the driver being unknown 42. If a driver is selected from the drop down list 40, the driver and selected passengers/friends may be eligible to earn point multiples 44 above and beyond what they would normally have earned without selecting a passenger/friend.

The application may also display driving reminders to the user, such as recommendations on where to locate the smartphone in the vehicle while driving, or reminders related to the time of day, the current weather conditions, prior driving sessions, and the like.

The application may also optionally display a points leaderboard 46 on the display screen of the smartphone. If utilized, the leaderboard can display various points data 48 that may be of interest to the user, such as the point totals of the user's friends, a regional or other geographical based points comparison, a points comparison based on an association or affiliation, or a national points ranking.

Another optional feature of the application is to display specific contest actions or other actions 50 that need to be taken by the user before or during a driving session. For example, the user may be required or asked to take a picture 52, for example a picture of the odometer using the smartphone before starting to drive, or a picture of the location where they are at, or a picture of a friend(s), or a picture of a particular retail store.

Once these preliminary items are completed, the application then enters driving mode 60 where it is ready to begin collecting and sending data regarding the driver's driving behavior during the driving session. For example, data 62 that can be collected and used to judge driving behavior include, but are not limited to, one or more of driving time from start to end, speed, path of travel, type of roads traveled on, whether or not there were any driving violations such as violation of traffic control signs like stop signs or the like, hard braking by the driver, and contextual information such as the weather or time of day. Some of this data can be collected using the GPS device on the smartphone together with a detailed mapping system to determine the location of the vehicle, the posted speed limit at that location, any traffic control signs at that location, etc. Other data can be gathered using the standard features available on modern day smartphones, for example an accelerometer.

The real time driving behavior data gathered during the driving mode 60 is sent by the smartphone to the server 14 for determination of points to be awarded. Furthermore, during the drive, certain data may be sent from the server to the smartphone. For example, if the driver violates a traffic control sign or a posted speed limit, a warning can be sent to the user's smartphone and displayed on the smartphone's display screen warning of the violation. In addition, an audible notification can be provided to the user using the speaker of the user's smartphone, audibly indicating a violation of a traffic control sign, excessive speed, excessive maneuvers, hard braking, and the like. Another option is to send a notice from the server 14 to a third party, such as a parent or employer of the driver, warning the parent or employer of violations such as excessive speed or violating a traffic control sign.

While in the driving mode 60, automatic audible coaching reminders can be provided to the user using the speaker of the user's smartphone. The coaching reminders can include, but are not limited to, advising of upcoming speed limit changes, upcoming turns or traffic control signs, changes in road conditions, etc.

In some embodiments, while the application is on, the application automatically blocks all incoming phone calls, texts and e-mails to the smartphone. However, it is possible to create a list of individuals from whom phone calls, texts and e-mails will not be blocked. An automatic response can be sent to any blocked caller, texter or e-mailer advising that the user is driving and currently unavailable to respond.

The driving session can be ended 64 automatically (as discussed further below) or manually, similarly to turning the application on. When the driving session ends 64, the application may again optionally display specific contest actions or other actions 66, similar to the actions 50, that need to be taken by the user at the end of the driving session. For example, the user may be required or asked to take a picture 68, for example a picture of the odometer using the smartphone before starting to drive, or a picture of the location where they are at, or a picture of a friend(s), or a picture of a particular retail store. In addition, the blocking of phone calls, texts and e-mails is turned off.

At the end of the driving session, the server 14 sends data back to the smartphone for display 70. For example, the points earned during the completed driving session and/or total accumulated points of the user 72 can be displayed to the user. To enhance social interactions, the application may also allow the user to compare the user's score against friends 74 and/or allow the user to share the user's score 76 via social networking, such as on Facebook or Twitter.

The gamification and social networking aspects of the driving coaching system and method can be enhanced by a web portal that is accessible to the user. With reference to FIG. 2B, one exemplary embodiment of the functionality of the web portal hosted by the server 14 or the server 16 is illustrated. The user initially logs into the web portal 80 which presents to the user a number of possible gamification and social networking features.

One such feature can be referred to as a Friend Center 82. In the Friend Center 82, the user can select, assign and invite the individuals that will be available for selection in the drop down lists 34, 40, invite friends 84 to join the user's group, or send out a request to join other groups 86.

Another feature can be referred to as a Comparisons Center 90. In the Comparisons Center 90, the user can compare his or her driving performance(s) and/or awarded points to others, such as friends 92; a predetermined group 94 such as driving school class; and state, national or other geographic or demographic groups 96. The Comparisons Center 90 can also provide various visible and hidden levels 98 that a user can achieve based on their driving behavior, and once achieved, an announcement of those achieved levels can be distributed to the user's friends or made visible to the user's friends.

Another feature can be referred to as a Challenge Center 100. In the Challenge Center 100, the user can challenge friends 102, for example to accumulate a certain number of points in a period of time, or pledge 104 to not have any traffic or speed violations over a period of time. The reward for winning a challenge or a pledge can be additional points. Conversely, losing a challenge or pledge can result in loss of points.

Another feature can be referred to as a Contest Center 110. In the Contest Center 110, the user can sign up for various contests sponsored by entities such as schools 112, commercial/retail establishments 114, or other sponsors 116. For example, a school may sponsor a safe driving contest that the user may sign up for to try and earn additional points or prizes based on their driving behavior. Commercial/retail establishments may sponsor a contest to encourage user's to drive by or frequent their stores. Many other contests are possible.

Another feature can be referred to as a Redemption Center 120. In the Redemption Center 120, the user can redeem their accumulated points for prizes/merchandise, services, discounts, or other benefits of tangible or intangible value. The user may be allowed access to a basic catalog 122 of points redemption options, or a featured catalog 124 of redemption options. There may even be a location/retailer specific redemption center 126, where a user can earn points based on how often the user drives by the sponsoring retailer, and redeem those earned points in the redemption center 126.

The web portal can also include links to social networking sites 128 such as Facebook and/or Twitter, as well as allowing the user to add comments 130.

The web portal may also display non-gamification features such as a dashboard that displays the user's overall points total, category score, recent trips, recent awarded points, rankings relative to others, and other information. Specific driving sessions may also be accessed by displaying a list of recent driving sessions, the ability to select a single driving session, and display information such as the driving time, speed(s), path, type of roads, traffic sign and speed violations, weather, time of day, and the like of that driving session.

The web portal can also display a “coaches corner” that provides suggestions to improve the points awarded and specific suggestions to the user for improving their driving.

Auto-Control

The auto-start 24 and auto-end features of the safe driving coaching system application loaded onto the smartphone will now be described. The auto-start and auto-end features can be initiated by one or more predetermined trigger events detected by the smartphone. The trigger events can be internally configured into the application, and presented to the user via the user interface of the smartphone to allow the user to select a particular trigger event. The trigger events can also be non-user selectable, resulting from one or more external signals being received by the smartphone. Regardless of whether the trigger event(s) is user selectable or not user selectable, detection of the trigger event(s) causes the safe driving coaching system application to auto-start or to auto-end without the user interacting with the smartphone.

With reference to FIG. 3, an exemplary screenshot of the preferences screen 200 of the safe driving coaching system application displayed on the smartphone display screen is shown. As would be understood by a person of ordinary skill in the art, the preferences screen 200 is reached by the user selecting a suitable button or icon assigned to the user preferences screen. The preferences screen includes a selectable menu option 202 for setting auto-start trigger features. When the user selects the menu option 202, the exemplary screen 204 shown in FIG. 4 is displayed.

As illustrated, the screen 204 includes one or more user selectable menu options associated with user selectable trigger events to initiate auto-start. The menu options illustrated in FIG. 4 are exemplary and can include Auto-start via motion 206 and auto-start via Bluetooth 208.

When selected, the auto-start via motion 206 option automatically starts the driving mode 60 or “trips” of the safe driving coaching system application when driving of the vehicle in which the smartphone is located is detected. Auto-start can occur if certain criteria are met, such as the use is logged into the application, the auto-start via motion option is selected, map data is downloaded, and other general application requirements such as acceptable software version, presence of GPS, and the like.

One exemplary method of detecting driving using an Android® based smartphone is as follows:

The application requests location updates from the network location provider (wifi or cell tower). Location updates are requested once the application determines that it is OK to try auto-starting the driving mode 60 (i.e. the criteria for auto-start are met).

Preferably, the application supplies criteria to the network location provider specifying how often and when the location updates are to be provided to the application. For example, in one embodiment, the application specifies that location updates should be given to the application no more than about every 30 seconds and only when the smartphone device has moved 100 meters. Although the application requests location updates when auto-starting, it only receives these updates when the OS has a new location update that meets the application's criteria (for example, 30 seconds and 100 meters). The OS won't tell the application about a location update unless the criteria are met.

In the case of the Android OS, location updates from the network location provider are initially used by the application instead of the GPS module, to preserve battery life. These initial location updates are satisfactory because the smartphone's current location does not need to be known with a lot of accuracy. Rather, this is sufficient to get a general sense of the smartphone's movement.

However, the GPS module is later used to double check movement. When the application determines, based on the location updates from the network location provider, that the smartphone has moved enough to meet the criteria, the application enables location updates from the GPS module, but only if the driving mode 60 is not already in-progress. The application then relies on the GPS module of the smartphone for new location updates.

After seeing five consecutive GPS location updates with speeds greater than or equal to about 15 mph, and an accuracy ≦20 meters, the application auto-starts the driving mode 60 if the driving mode 60 is not already in-progress.

If a predetermined time period, for example 120 seconds, passes without the driving mode auto-starting, the application stops listening for GPS location updates from the GPS module to conserve battery life of the smartphone.

Once auto-started, the driving mode 60 can also be auto-ended due to inactivity. For example, if the vehicle speed is unknown for a predetermined period of time, for example for 5 minutes, which could occur due to inaccurate or disabled GPS, or the vehicle speed is less than a predetermined amount, for example 5 mph, for a predetermined period of time, for example 5 minutes, the driving mode 60 can be auto-ended. Also, if driving is not detected for a predetermined period of time, for example 5 minutes, the driving mode 60 can be auto-ended. A message can be displayed on the display screen of the smartphone indicating that the trip was ended automatically.

When selected, the auto-start via Bluetooth 208 option automatically starts the driving mode 60 or “trips” of the safe driving coaching system application when a selected Bluetooth device is connected to the smartphone. The auto-start via Bluetooth 208 is preferably off by default and requires the user to select the menu option 208 to enable it. When the option 208 is selected, the user will be able to select from a list of Bluetooth devices by selecting menu option 210 which will present a drop down list of available Bluetooth devices to choose from that are paired with the smartphone.

If the user's smartphone does not have Bluetooth capability, the option 208 will be disabled by being grayed out and a suitable message can be shown indicating that the user's smartphone does not support Bluetooth. If the smartphone's Bluetooth is disabled (i.e. turned off) a suitable message can be displayed indicating such and providing a button or other link for the user to select to access the smartphone's Bluetooth settings.

Once the driving mode 60 is auto-started via the Bluetooth option, the driving mode can be auto-ended when the Bluetooth device is disconnected.

Another option for triggering auto-start and/or auto end of the driving mode 60 is based on what can be termed predetermined time criteria. For example, auto-start and/or auto-end can be triggered at a particular time(s) of the day using the clock or alarm feature of the smartphone. A menu option can be provided on the screen to allow the user to specify the start and/or end time(s), with the application then relying on the internal clock of the smartphone to trigger auto-start and/or auto-end when the time is reached. Alternatively, the predetermined time criteria can be established from outside of the smartphone, for example on the web portal discussed above which allows the start and/or end time(s) to be selected, and a trigger signal then being sent to the smartphone once the selected time(s) is reached to trigger auto-start and/or auto-end.

The auto-start and/or auto-end features can also be triggered via other external signals received by the smartphone. For example, a parent of the driver can send a trigger signal to their child driver's smartphone to trigger auto-start and/or auto-end. The trigger signal could be in the form of a text, an e-mail or other signal that can be interpreted by the smartphone. The trigger signal from the parent could be sent from the web portal discussed above or directly from the parent's own phone.

Another auto-start and/or auto-end trigger can be based on geo-fencing. Once the smartphone is within a predetermined range of a location, auto-start and/or auto-end can be triggered either automatically by the smartphone, or by an external signal received by the smartphone. The trigger can be based on proximity to a city or a particular location within a city such as a school or even a particular commercial/retail establishment.

Other auto-start and/or auto-end triggers can be used, both triggers internal to the application and smartphone and external trigger received by the smartphone.

The examples disclosed in this application are to be considered in all respects as illustrative and not limiting. The scope of the invention is indicated by the appended claims rather than by the foregoing description; and all changes which come within the meaning and range of equivalency of the claims are intended to be embraced therein.

1. A safe driving coaching method comprising:
receiving data at a server concerning the driving behavior of a driver of a vehicle, the server being remote from the vehicle;
assigning points to a user's account based on the received data concerning the driver's driving behavior, the user's account being stored on a server; and
allowing the user to access the user's account via a web portal that is accessible on a desktop computer, a tablet computer or a smartphone.

2. A server comprising:
a safe driving coaching web portal hosted by the server, the safe driving coaching web portal displaying a plurality of gamification options selectable by a user, the gamification options permitting the user to utilize points that have been accumulated by the user based on safe driving behavior.

3. A method comprising:
auto-controlling a safe driving coaching application loaded onto a smartphone by auto-starting and/or auto-ending the safe driving coaching application on the smartphone upon receipt of a trigger signal that is triggered by a trigger event.

4. The method of claim 3, wherein the trigger signal is internally generated by the smartphone or is an external signal received by the smartphone.

5. The method of claim 3 in the form of a software application loaded onto a smartphone having a display screen, the application is configured to display to the user on the display screen one or more selectable auto-start options that when selected auto-start the application.

6. The safe driving coaching application of claim 5, wherein the display screen displays a plurality of auto-start options, each auto-start option representing a different triggering event that triggers auto-start of the application.
